(19) United States
(12) Patent Application Publication
(10) Pub. No.: US 2004/0219982 A1
(43) Pub. Date: Nov. 4, 2004

(54) Apparatus and method for automatically tracking gambling habits

(76) Inventors: Denis Khoo, Arcadia, CA (US); Raymond F. Ratcliff III, Plano, TX (US)

Correspondence Address: DENIS KHOO, 9729 CAMINO REAL, ARCADIA, CA, 91007, US

(21) Appl. No.: 10/428,468

(22) Filed: May 2, 2003

(51) Int. Cl. G06F 19/00

(52) U.S. Cl. 463/42

(57) ABSTRACT

The invention provides an accurate and automatic method of tracking a player's gambling habits in a casino while playing at a gaming table. Currently, this is done by visual observation by a casino worker within most casinos.

A casino is able to track a player's gambling habits by using RFID technology to track the amount of a bet by a particular player. First, a player identifies him or herself. Preferably, through the use of an identification card and an identification card reader. Each gaming chip is embedded with a transponder which allows each gaming chip to be tracked during a bet. The gaming table is equipped with an antenna, which is controlled by a transceiver. Ultimately, the player's gaming habits are tracked and stored within the casino's computer system.

### BACKGROUND OF THE INVENTION

1. Field of the Invention

The present invention relates generally to gambling habits, and more particularly, to an automated method of tracking a player's gambling habits.

2. Description of the Related Art

Casinos generate a significant portion of their revenue from gambling. Casinos also provide other services, such as extravagant hotel rooms, shows, musicals, and restaurants to drive up profits. Nonetheless, gambling is still a very significant source of revenue for casinos, and thus, they would like to entice gamblers (aka players) to gamble as much as possible.

As casinos compete against each other for a player's business, they frequently attempt to persuade

players to gamble at their particular casino by providing incentives. Similar to the airline industry which provides frequent flyer miles as an incentive for flyers to stick with a particular airline, casinos provide what is known as the players club to keep players to stick with a particular casino. As seen in FIG. 1, a player joins the players club by signing up 120. Thereafter, the player's information is entered into the casino's computer system 125, and the player receives a players club card. The players club card is a convenient means for the casino to identify a particular player.

The casino's computer system contains information about each player who has signed up to join the players club. All future gambling habits of the player can be recorded and stored using the same computer system.

When a player (who already has a players club card) gambles at a gaming table, the player first decides which gaming table to play at 130, and the desired position at the particular gaming table 140. After deciding the gaming table and position, the player presents his/her players club card to the casino worker 150 who is usually located behind the gaming table. The casino worker is able to identify the player via the players club card, and will keep an eye on the player's gambling habits 160. It is up to this casino worker to track and estimate the player's gambling habits 170. The casino worker eventually enters a record of the estimated player's gambling habits into the casino's computer system 180 from a computer terminal that is in close proximity to the casino worker. This information gets sent to the casino's main backend computer system and information about the player is updated 190. In addition, based on the gambling habits entered by the casino worker, the casino's computer system will award the appropriate points to the player 190.

When a player gambles at a slot machine, the player is able to insert the players club card into a players club card slot located directly on the slot machine. The player keeps his/her card in the slot for the entire duration while gambling at the particular slot machine, and all the while, the player's gambling habit is recorded into the casino's computer system.

The casino typically has a point system that it uses to determine how much the player has gambled. So the more a player gambles, the more points the player will receive. The casino uses a proprietary algorithm for calculating points based on the duration of gambling and the amount of the bets. The player, depending on the number of points available, can redeem the points for prizes such as a free room, free show tickets, free meal, or other services offered by the casino.

The point system is a very powerful incentive tool to get players to gamble at a particular casino, and the points are also quite valuable, as they can be redeemed for valuable prizes. It is therefore important to keep an accurate recording of a player's gambling habits so that the appropriate points can be awarded to the player.

Slot machines accurately record a player's habit because the entire recording process is automated and requires no human intervention. However, when gambling at a gaming table, a player's gambling habits are determined and recorded by the casino worker, leaving much room for error and even mischief. There needs to be a more accurate means of tracking a player's gambling habits while he/she is playing at a gaming table.

### SUMMARY OF THE INVENTION

The present invention provides for a more accurate means of tracking and recording a player's gambling habits while a player is gambling at a gaming table. The invention is applicable to current gaming tables where a player's bet is placed in a specific area of the gaming table, and the specific area can be associated with the player. Examples of such gaming tables include a Blackjack gaming table, Pai Gow Poker gaming table, and a Spanish 21 gaming table. This invention is adaptable to gaming tables where bets of multiple players are mixed together on the gaming table, such as with Roulette and Craps.

The player first identifies himself/herself at the gaming table, typically with the use of his/her players club card. The player can identify himself manually or automatically. If manually, the player provides his/her players club card to the casino worker, and the casino worker will associate the player with a specific area on the gaming table for the player to place his/her bets. If automatically, the player chooses a position on the gaming table where he/she wants to gamble, and inserts the players club card into a players club card slot for that position. The players club card slot is ideally located directly in the table in close proximity to the position for which it is associated.

Once the player has been identified, and the position where the player is going to gamble has been selected, the tracking system is activated, and the player's gaming habits are now tracked. Using RFID, the system is able to track the bet amount within the specific betting area for the particular player. This information can be sent to and recorded by the casino's computer system.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a prior art flowchart diagram for tracking a player's gaming habits.

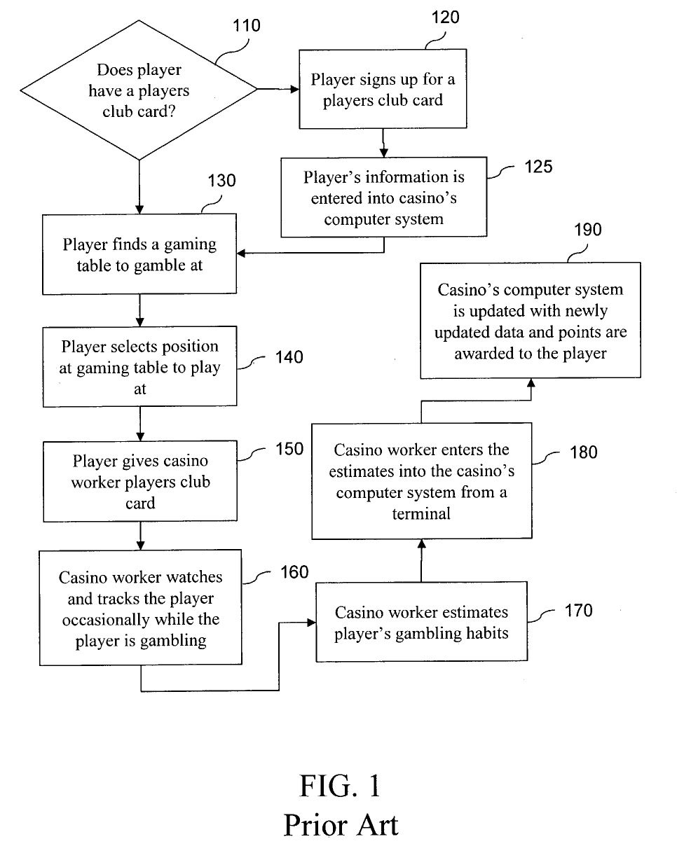

FIG. 2 is a flowchart diagram for a preferred embodiment of automatically tracking a player's gaming habits.

FIG. 3 is a flowchart diagram for a preferred embodiment of automatically tracking a player's gaming habits.

FIG. 4 is a technical block diagram of an embodiment of the system of the present invention.

FIG. 5 is a top view of a gaming table used in a preferred embodiment of this invention.

FIG. 6 is a top view of a gaming tabled used in a preferred embodiment of this invention.

### DETAILED DESCRIPTION OF THE PREFERRED EMBODIMENTS

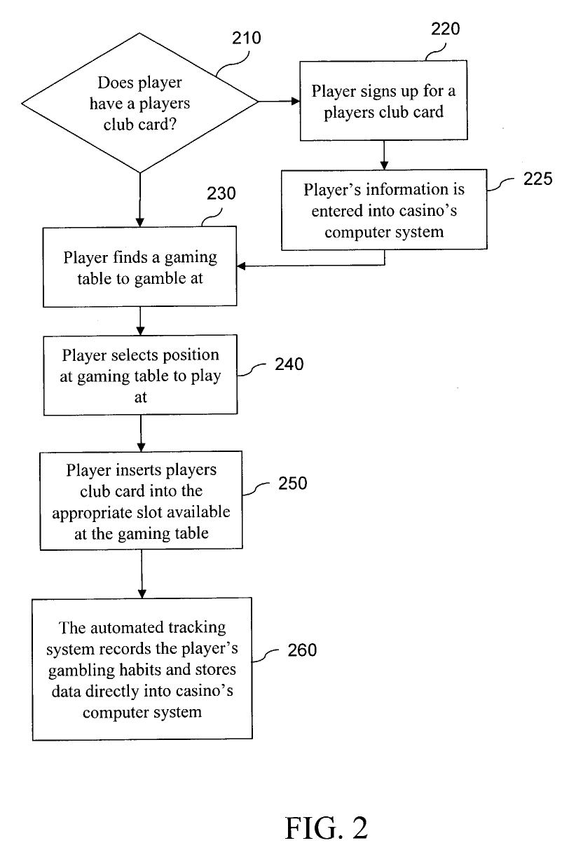

FIG. 2 is a flowchart diagram of a preferred embodiment of this invention. In the first step 210, the player determines if he/she already has a players club card. If the player does not, the player may sign up for a players club card in step 220. After signing up, the players information is entered into the casino's computer system in step 225. This information includes personal information such as the players name, address, phone number, and other questions that the casino might want answered about the player.

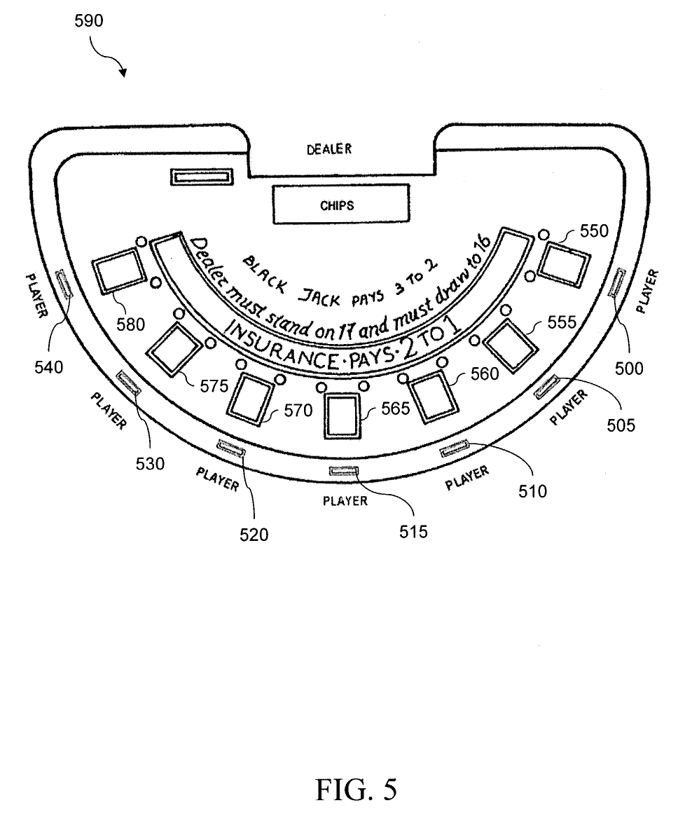

After obtaining a players club card, the player may now accrue points under this account by gambling in the casino with the card. In the next step 230, the player locates a gaming table that the player would like to gamble at. Each gaming table allows for multiple players to play simultaneously. In step 240, it is up to the player to decide which position to play at. For example, FIG. 5 shows a Blackjack table, which typically offers seven positions, plus the dealer's position which is not available to players. Cards are typically dealt to position one 550, and then position two 555, and so on. In Blackjack, cards are dealt to a particular position only if there is a player gambling at that position. In step 240, the player decides which position to play at, and may choose from positions that are not already occupied.

Having decided the gaming table and the position to play at, the player is now ready to begin gambling. In order for the casino to acknowledge the player's gambling and award the player with points, the player needs to let the casino know of his/her gambling. In a preferred embodiment of this invention the player merely has to perform the simple step of inserting his/her players club card into a players club card slot on the gaming table. For example, if the player had decided to gamble at position three 560, the player would insert his/her players club card into players club card slot 510. The player keeps the card in the slot for as long as the player wants his gambling to be tracked while gambling at this particular gaming table and particular position.

While gambling at a gaming table, the system is automatically tracking the player's gambling habits and storing this data into the casino's computer system, as shown in step 260. The technical details of how the system automatically tracks the player's gambling habits will be discussed further below.

The tracking system greatly improves the accuracy of monitoring a player's gambling habits, and makes it significantly more convenient for the player to accumulate points under his/her account. A player may ultimately determine which casino's gaming table to gamble at depending on whether or not this service is available.

If the player decides to switch positions at the gaming table, the player merely needs to remove his/her players club card from the slot, choose a new position, and insert the players club card in the slot associated with the new position. The player can then immediately begin gambling knowing that the bets will continue to be tracked by the system.

If the player decides to switch gaming tables, the player removes his/her players club card from the slot, and continues at step 230.

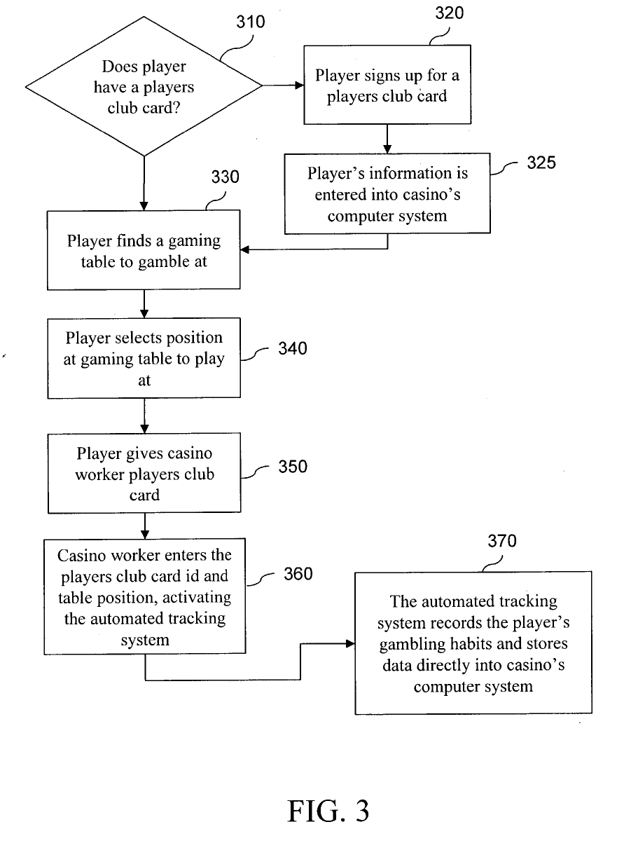

FIG. 3 is another flowchart diagram of a preferred embodiment of this invention. The initial steps of determining if the player has a players club card, signing up for a players club card, storing the player's information in the casino's computer system, finding a gaming table to gamble at, and selecting a position to play at, as shown in step 310, step 320, step 325, step 330, and step 340 respectively, are identical to the corollary steps of the previous preferred embodiment.

In step 350, the gaming table does not provide a players club card slot, so the player must present his/her players club card to a casino worker. Thereafter, in step 360, the casino worker enters the players club card identifier and table position into the system, and activates the tracking system. As seen in step 370, the system will now automatically track the player's gambling habits and store this data into the casino's computer system. The technical details of how the system automatically tracks the player's gambling habits will be discussed further below.

If the player decides to switch positions at the gaming table, the player informs the casino worker, and the casino worker will enter the new position into the computer system, and activate automatic tracking for the player at the new position.

When the player leaves the gaming table, the casino worker deactivates the tracking system for the player.

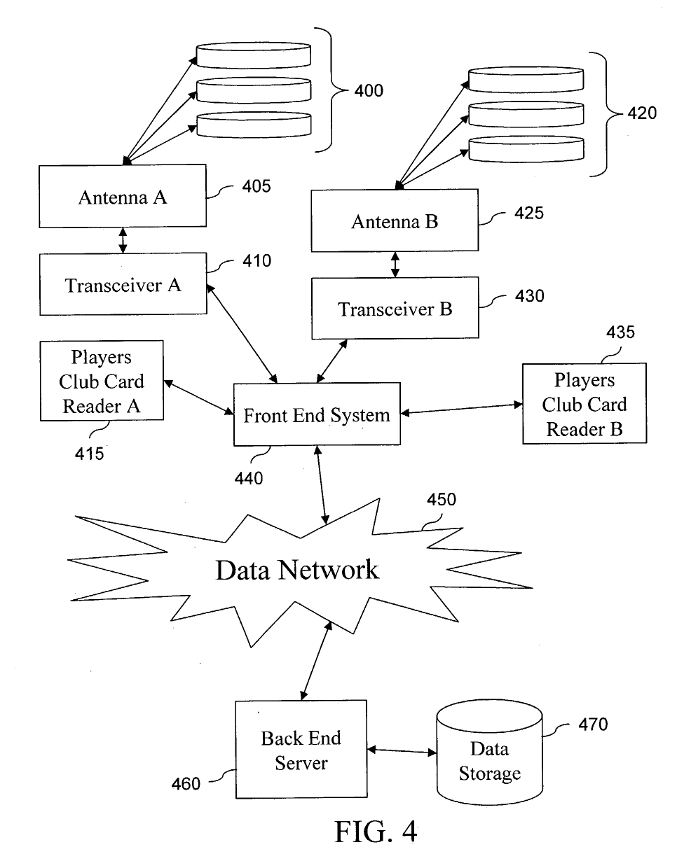

FIG. 4 is a technical block diagram of an embodiment of the present invention. For simplicity, the technical block diagram of FIG. 4 works with a gaming table with two positions. Of course, this can easily be adjusted to accommodate any number of positions at a gaming table.

FIG. 4 shows two sets of gaming chips 400 and 420. Each gaming chip is embedded with a transponder which allows the chip to maintain information about itself. The transponder contains data about the value of the chip and a unique identifier for the chip. This data can be read by the transceiver 410 and 430 via an antenna 405 and 425.

In order for the transceiver to read the data from the transponder, the antenna emits a radio signal which activates the transponder within the gaming chip. Thereafter, the transceiver is able to read the data from the transponder in the gaming chip via the antenna. The antenna can be customized to activate transponders in a certain area by customizing its power output and radio frequency. Thus, even though both sets of gaming chips 400 and 420 are on the same gaming table, it is possible for antenna A 405 and transceiver A 410 to activate and read data from the transponders in gaming chips 400, while antenna B 425 and transceiver B 430 only activate and read from the transponders in gaming chips 420.

For example, the Blackjack table 590 could have transceiver A 410 and antenna A 405 used to activate and read from all transponders placed within the betting area 550. In addition, transceiver B 430 and antenna B 425 could be used to activate and read from all transponders placed within the betting area 555. As shown in FIG. 5, betting area 550 is designated for the player at position one, and betting area 555 is designated for the player at position two. This example shows how bet amounts can be automatically tracked for each and every position at a gaming table.

The bet amount needs to be associated with a particular player. This is done by having a players club card reader 415 and 435. Players club card reader 415 is associated with the bet tracking technology of antenna A 405 and transceiver A 410. Players club card reader 435 is associated with the bet tracking technology of antenna B 425 and transceiver B 430. The players club card readers 415 and 435 can be a magnetic strip card reader or smartcard reader. The players club card readers 415 and 435 have the ability to read the players club card so that the player can be easily identified.

In the Blackjack table 590, the players club card reader A 415 would associated with position one, and would use the slot opening 500. The players club card reader 435 would be associated with position two, and would use the slot opening 505. If a player decided to gamble at position one, the player would insert his/her players club card into players club card slot 500, and the players club card would be read by the players club card reader 415. It is also possible to allow the use of a standard card such as a credit card or driver's license as a means of identifying the player.

The system is able to track the amount of bets in a specific position, and can identify the player that is gambling at a specific position. This information is sent to a front-end computer system 440. The front-end computer system 440 eventually will send this information to a back-end server 460 via a data network 450. The data network 450 can be a wired or wireless data network. The back-end server 460 stores this information to its data storage 470. The back-end server 460 also calculates the number of points awarded to the player based on the information received about the player's gambling habits.

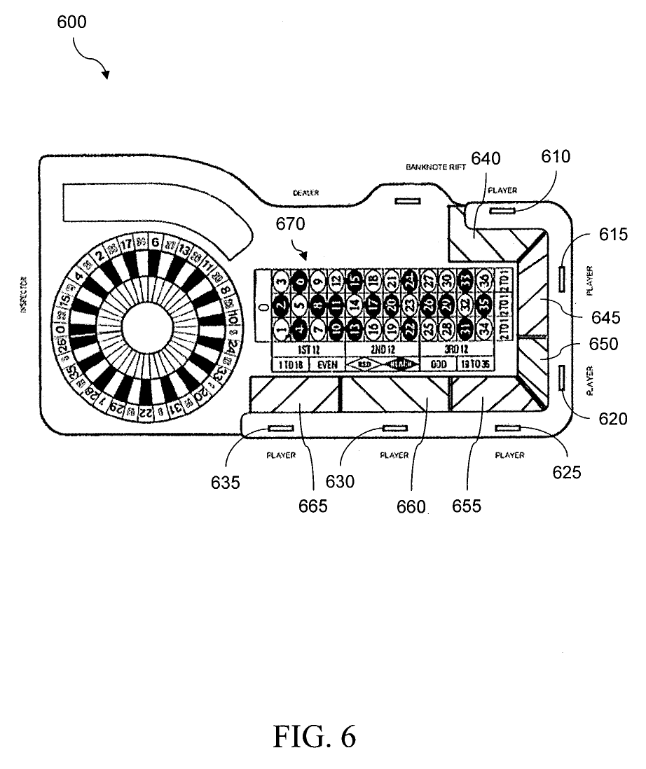

FIG. 6 shows how a Roulette gaming table 600 can be adapted to be used with this invention. A Roulette gaming table, unlike a Blackjack gaming table, does not isolate one player's bet from another's. Instead, bets are spread all throughout the betting area 670, with gaming chips from multiple players being placed concurrently in the same betting area 670.

The Roulette table 600 allows for six different positions, and thus six players. Player one is provided with the players club card slot 610, player two is provided with the players club card slot 615, and so on. Each position also contains a gaming chip holding area. As each player joins the Roulette gaming table, a casino worker will exchange the player's standard gaming chips with special colored gaming chips. These special colored gaming chips help to distinguish the bet of one player from another. These special colored gaming chips are also embedded with transponders.

When a player receives the special colored gaming chips, he/she will place them in the gaming chip holding area. Each position is equipped with a gaming chip holding area. Player one has gaming chip holding area 640, player two has gaming chip holding area 645, and so on.

For example, player one will insert his/her players club card into players club card slot 610. After receiving his/her special colored gaming chips, player one will place these chips in gaming chip holding area 640. After doing so, a transceiver, via an antenna, will read the special colored gaming chips in gaming chip holding area 640. The system can now maintain an association between a specific colored gaming chip and the player in position one.

When bets are placed in betting area 670, another transceiver, via an antenna, will read from all special colored gaming chips in the betting area 670. By doing so, the system is able to determine how much each player is betting. This information is received by the transceiver and eventually sent to the back-end server 460 over the data network 450, and stored in the data storage 470. Thus, the process of tracking a player's gambling habits area automatically tracked and recorded. Although the present invention has been described in detail with respect to certain embodiments and examples, variations and modifications exist which are within the scope of the present invention as defined in the following claims.

What is claimed is:

1. A method for tracking gambling habits on a gaming table comprising the steps of:
embedding a plurality of gaming chips with transponders;
programming each said embedded transponder with information about the gaming chip;
identifying a betting region on said gaming table where at least one of said gaming chip is placed for betting;
identifying a player playing at said betting region;
reading said information from at least one of said gaming chip in said betting region; and
storing said information about said gaming chip in said betting region and identity of said player.

2. The method as recited in claim 1, wherein said storing step further comprises the substeps of:
transmitting said information about said gaming chip in said betting region and identity of said player to a server over a data network; and
storing said information in a data storage.

3. The method as recited in claim 1, wherein said step of identifying said player is by inserting an identification card into a slot embedded within said gaming table for reading.

4. The method as recited in claim 1, wherein said step of identifying said player is by presenting an identification card to a casino worker.

5. The method as recited in claim 1, wherein said information programmed onto said embedded transponder comprises of a unique identifier and a monetary value.

6. The method as recited in claim 1, wherein said step of reading said information from at least one of said gaming chip in said betting region is through the use of a transceiver and an antenna.

7. The method as recited in claim 6, wherein said antenna is customized to a specific power output and specific radio frequency, as to only read from said gaming chips in said betting region.

8. A method of tracking gambling habits on a gaming table comprising the steps of:
embedding a gaming chip with a transponders;
programming said embedded transponder with information about said gaming chip;
associating a player with said gaming chip;
identifying a betting region on said gaming table where said gaming chip is placed for betting;
reading said information from said gaming chip in said betting region;
storing said information about said gaming chip and said player.

9. The method as recited in claim 8, wherein the step of associating further comprises the substeps of:
inserting said player's identification card into a slot embedded within said gaming table for reading;
identifying a gaming chip holding area;
placing said gaming chip in said gaming chip holding area; and
reading said programmed information about said gaming chip from said gaming chip holding area.

10. The method as recited in claim 8, wherein said programmed information comprises of monetary value, unique and identifier.

11. The method as recited in claim 8, wherein the reading step is through the use of a transceiver and antenna.

12. The method as recited in claim 11, wherein said antenna is customized to a specific power output and specific radio frequency, as to only read from said gaming chip in said betting region.

13. The method as recited in claim 8, wherein the storing step further comprises the substeps of:
transmitting said information about said gaming chip in said betting region and said player to a server over a data network; and
storing said information into a data storage.

14. An apparatus comprising:
a gaming chip, having a transponder embedded within, said transponder containing information about said gaming chip;
a gaming table with an identified region for placing bets;
a transceiver and antenna for obtaining information about said gaming chip when placed within said identified region;
a processor for associating said identified region with a player; and
a storage medium for storing said information about said gaming chip and said player associated with said identified region.

15. The apparatus of claim 14, further comprising a transmitting means for transmitting said information about said gaming chip and said player.

16. The apparatus of claim 14, further comprising a server system for awarding points to said player based on said information about said gaming chip.

17. The apparatus of claim 14, wherein said antenna is customized to a specific power output and specific radio frequency, as to only read from said gaming chip in said identified region.

18. The apparatus of claim 14, further comprising an identification card reader and slot embedded within said gaming table.

19. The apparatus of claim 14, wherein said information about said gaming chip includes a unique identifier and a monetary value.

20. An apparatus comprising:
a gaming chip, having a transponder embedded within, said transponder containing information about said gaming chip;
a gaming table with an identified region for placing bets;
a transceiver and antenna for obtaining information about said gaming chip when placed within said identified region;
a processor for associating said gaming chip with a player; and
a storage medium for storing said information about said gaming chip and said player associated with said gaming chip.

21. The apparatus of claim 20, wherein said antenna is customized to a specific power output and specific radio frequency, as to only read from said gaming chip in said identified region.

22. The apparatus of claim 20, further comprising an identification card reader and slot embedded within said gaming table.

23. The apparatus of claim 20, wherein said information about said gaming chip includes a unique identifier and a monetary value.
